(19) United States
(12) Patent Application Publication
(10) Pub. No.: US 2009/0266564 A1
(43) Pub. Date: Oct. 29, 2009

(54) High expansion foam fire-extinguishing system

(76) Inventor: Shinji Murata, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/379,865

(22) Filed: Mar. 3, 2009

(30) Foreign Application Priority Data
Mar. 7, 2008 (JP) 2008-058323
Mar. 31, 2008 (JP) 2008-091362

(51) Int. Cl. A62C 31/12

(52) U.S. Cl. 169/14

(57) ABSTRACT

In order to prevent foaming ratio from being degraded, there is provided a high expansion foam fire-extinguishing system (B) including: a foam generator body (1) formed to a tubular shape; a foam forming screen (2) arranged at a distal end (1a) side of the foam generator body (1); an emission nozzle (3) arranged at a back end (1b) side of an interior of the foam generator body, for radiating a foam solution (W) in an emission pattern (WP) that spreads in a conical shape towards the foam forming screen (2); and an intermediate screen (4) arranged between the foam forming screen (2) and the emission nozzle (3), in which the intermediate screen (4) is arranged in a liquid droplet speed regulating region from a landing position (P0) at which an outer periphery of the emission pattern (WP) hits an inner wall (1f) of the foam generator body to a limit position (P1) at which liquid droplets can pass through a mesh of the intermediate screen (4).

### BACKGROUND OF THE INVENTION

1. Field of the Invention

The present invention relates to a high expansion foam fire-extinguishing system used in a warehouse, a pit of an oil tank, a culvert of an oil industrial complex, a cabin, a hold, or the like.

2. Description of the Related Art

In a foam fire-extinguishing system, a foam solution is discharged from an emission nozzle and impinged on a foam forming screen to thereby suck air and generate foam, and the fire source is covered with such foam to extinguish the fire by smothering. The foam fire-extinguishing system in which a foaming ratio indicating a volume ratio of the foam solution and the generated foam is greater than or equal to 80 and smaller than 1,000 is referred to as a high expansion foam fire-extinguishing system.

Great amount of air needs to be taken in from the upstream side of the emission nozzle in order to generate high expansion foam such as foam having the foaming ratio of greater than or equal to 500, where a method of sucking air outside the room (referred to as “outside air”) is typically adopted when taking in great amount of air.

However, the method using outside air has problems such as increase in cost, because a duct needs to be passed through a building or a hole needs to be formed in a separating wall to arrange a foam generating machine (foam generator) to use the air outside.

In order to solve such problem, a high expansion foam fire-extinguishing system of a method of sucking air within a section in which the foam is discharged (referred to as “inside air”) is used (see e.g., JP 06-165837 A).

In such high expansion foam fire-extinguishing system of inside air, the foaming ratio significantly degrades compared to the high expansion foam fire-extinguishing system of outside air, but the main factor thereof lies in the “smoke” generated in the room due to the occurrence of fire.

Such smoke floats in the room as solid microparticles such as microparticles having a particle diameter of smaller than or equal to 1 μm. When mixed with the air of the emission section and sucked by an air suction part, such microparticles are supplied to a foaming part together with air thereby degrading the foaming ratio.

The inventors of the present invention found that smoke particles merely need to be removed to solve such problem, but considered whether the degradation of the foaming ratio can be prevented without removing the smoke particles.

Foam such as high expansion foam is generally a two-layer film of a surface active agent contained in a foam liquid and is configured by an inner thin-film and an outer thin-film with a hydrophilic region therebetween, where the thin-films are in a foam state containing air while being simultaneously formed side by side. The inventors of the present invention believed that the reason the foaming ratio is not satisfactory when foreign substance such as smoke particles exists is because the speed of the liquid droplet of the foam solution from the emission nozzle becomes too fast when the emission nozzle is operated at the standard setting, and the thin-films cannot be formed on time and cannot be simultaneously formed side by side thereby allowing the particles to pass through the mesh of the foam forming screen.

The speed of the liquid droplet of the solution may be slowed down, where arranging a mesh-form flow regulating part close to the inner side of the foam forming screen is conceived as means for slowing down the speed (see e.g., Japanese Utility Model Application Laid-open No. Hei 05-053660). In such means, the speed of the water droplets of the foam solution discharged from the emission nozzle is reduced by passing through the flow regulating part, and the water droplets impinge the foam forming screen in such speed-reduced state and generate foam.

In the related art, the force of the foam solution impinging the flow regulating part is weak because the space between the emission nozzle and the flow regulating part is long, and thus there is a high possibility that foam may generate at the stage of impinging the flow regulating part. The foam solution passes the flow regulating part in a liquid state as it is when the speed is fast, but becomes a foam when passing the flow regulating part when the speed is reduced to a certain extent.

The foam forming screen and the flow regulating part are arranged adjacently to each other, and hence the foam generated when the foam solution impinges the flow regulating part accumulates in a gap at an attachment position of the foam forming screen and the flow regulating part, and the accumulated foam becomes a hindrance in taking in air. As a result, the foam may not be satisfactorily generated from the foam forming screen. That is, the entire area of the foam forming screen cannot be used to generate foam because part of the mesh of the foam forming screen is blocked by the foam generated by the flow regulating part. Thus, the foaming ratio may not be as designed.

As a solution for such problem, consideration is made in not arranging the flow regulating part, reducing the emission pressure to smaller than the standard set pressure and dropping an injection speed of the emission nozzle so that it is difficult for the liquid droplets of the foam solution to pass through the mesh.

The foam state of the foam solution of a predetermined concentration was experimented with the emission pressure of the emission nozzle changed, where under the smoke condition in which the foaming ratio degraded to lower than or equal to ⅕ compared to the normal time when the injection pressure is 0.5 MPa, the foaming ratio degraded only to about ⅘ at 0.2 MPa.

Therefore, the foam easily generates when the emission pressure of the foam solution is dropped, but the air suction amount and the amount of discharging foam solution become smaller than the standard setting. Therefore, the amount of foam decreases and the desired amount of foam cannot be obtained within a predetermined time.

### SUMMARY OF THE INVENTION

In view of such circumstances, the present invention aims to prevent reduction in foaming ratio under smoke situation.

According to an aspect of the present invention, there is provided a high expansion foam fire-extinguishing system including: a foam generator body formed to a tubular shape; a foam forming screen arranged at a distal end side of the foam generator body; an emission nozzle arranged at a back end side of an interior of the foam generator body, for radiating a foam solution in an emission pattern that spreads in a conical shape towards the foam forming screen; and an intermediate screen arranged between the foam forming screen and the emission nozzle, in which the intermediate screen is arranged in a liquid droplet speed regulating region from a landing position at which an outer periphery of the emission pattern hits an inner wall of the foam generator body to a limit position at which liquid droplets can pass through a mesh of the intermediate screen.

In the aspect of the present invention, a length of the liquid droplet speed regulating region has a length obtained by multiplying an entire length of the foam generator body by 0.3. A wire diameter of the intermediate screen is between 0.5 to 0.8 mm, the number of meshes is seven or eight, mesh width is between 2.5 and 3 mm, and an aperture ratio is between 60 to 70%.

According to another aspect of the present invention, there is provided a high expansion foam fire-extinguishing system including: a foam generator body formed to a tubular shape; a foam forming screen arranged at a distal end side of the foam generator body; and an emission nozzle arranged at a back end side of an interior of the foam generator body, for radiating a foam solution towards the foam forming screen, in which a length of the foam forming screen is in a range from a length substantially the same as an entire length of the foam generator body to a length of substantially two thirds of the entire length.

In the another aspect of the present invention, the foam forming screen is bent to project to the distal end side so that a distal end angle thereof is set between 15° to 40°. In the another aspect of the present invention, at least two of the foam forming screens are arranged in a height direction of the foam generator body.

According to another aspect of the present invention, there is provided a high expansion foam fire-extinguishing system including: a foam generator body formed to a tubular shape; a foam forming screen arranged at a distal end side of the foam generator body; and an emission nozzle arranged at a back end side of an interior of the foam generator body, for radiating a foam solution towards the foam forming screen, in which a distal end of the foam generator body is extended within a range from a length substantially the same as an entire length of the foam generator body to a length of substantially two thirds of the entire length.

In the another aspect of the present invention, the foam forming screen is stretched in a direction orthogonal to a center axis of the foam generator body.

In the present invention, as described above, the intermediate screen is arranged within the liquid droplet speed regulating region from the landing position at which the outer periphery of the emission pattern hits the inner wall of the foam generator body to the limit position at which the liquid droplets can pass through the mesh of the intermediate screen, and thus the foam solution radiated from the emission nozzle passes through the intermediate screen while being subjected to resistance to have an appropriate foam flow speed, and thereafter, impinges the foam forming screen. Thus, degradation of the foaming ratio can be prevented.

In the present invention, the length of the foam forming screen is in a range from the length substantially the same as the entire length of the foam generator body to the length of substantially two thirds of the entire length, and thus the distance from the emission nozzle to the foam forming screen becomes longer than in the related art. Thus, the force (emission energy) of the foam solution radiated from the emission nozzle drops before impinging the foam forming screen, and thus the foam solution impinges the foam forming screen with reduced flow speed, whereby the foam easily generates, and the degradation of the foaming ratio under smoke situation can be alleviated.

The foam forming screen of the present invention is folded so as to project towards the distal end side, and the distal end angle is set between 15° and 40°, and thus the length of the foam forming screen projecting from the distal end of the foam generator body becomes long compared to the related art. Thus, an area of the foam forming screen becomes large compared to the related art, and a contacting area of the foam solution and the foam forming screen increases, whereby the foaming ratio is enhanced.

At least two of the foam forming screens of the present invention are arranged in the height direction of the foam generator body, and thus a large area (contacting area) of the foam forming screen of triangular prism shape can be obtained without increasing the projection amount from the distal end of the foam generator body. Therefore, the foam generator can be miniaturized.

In the present invention, the distal end of the foam generator body is extended within the range from the length substantially the same as the entire length of the foam generator body to the length of substantially two thirds of the entire length, and thus the distance from the emission nozzle to the foam forming screen becomes longer than in the related art. Thus, the force (emission energy) of the foam solution radiated from the emission nozzle drops before impinging the foam forming screen, and thus the foam solution impinges the foam forming screen with reduced flow speed, whereby the foam easily generates, and the degradation of the foaming ratio under smoke situation can be alleviated.

### BRIEF DESCRIPTION OF THE DRAWINGS

In the accompanying drawings:

FIG. 1 is a longitudinal cross-sectional view illustrating a first embodiment of the present invention;

FIG. 2 is a cross-sectional view taken along the line II-II of FIG. 1;

FIG. 3 is an enlarged front view of an intermediate screen;

FIG. 4 is a longitudinal cross-sectional view illustrating a second embodiment of the present invention;

FIG. 5 is a longitudinal cross-sectional view illustrating a third embodiment of the present invention;

FIG. 6 is a cross-sectional view taken along the line VI-VI of FIG. 5;

FIG. 7 is a longitudinal cross-sectional view illustrating an embodiment of the present invention;

FIG. 8 is a side cross-sectional view illustrating a fourth embodiment of the present invention;

FIG. 9 is an enlarged view of main parts of FIG. 8;

FIG. 10 is a side cross-sectional view illustrating a fifth embodiment of the present invention;

FIG. 11 is an upper cross-sectional view illustrating the fifth embodiment;

FIG. 12 is a side cross-sectional view illustrating a sixth embodiment of the present invention;

FIG. 13 is a side cross-sectional view illustrating a seventh embodiment of the present invention;

FIG. 14 is an enlarged view of main parts of FIG. 13;

FIG. 15 is a side cross-sectional view illustrating an eighth embodiment of the present invention;

FIG. 16 is a side cross-sectional view illustrating a ninth embodiment of the present invention;

FIG. 17 is a side cross-sectional view illustrating a tenth embodiment of the present invention; and

FIG. 18 is a schematic view illustrating an overall configuration of a high expansion foam fire-extinguishing system.

### DETAILED DESCRIPTION OF THE PREFERRED EMBODIMENTS

The inventors of the present invention believed that the above-mentioned problem could be solved by optimizing the position of the flow regulating part (intermediate screen), and performed the following experiments.

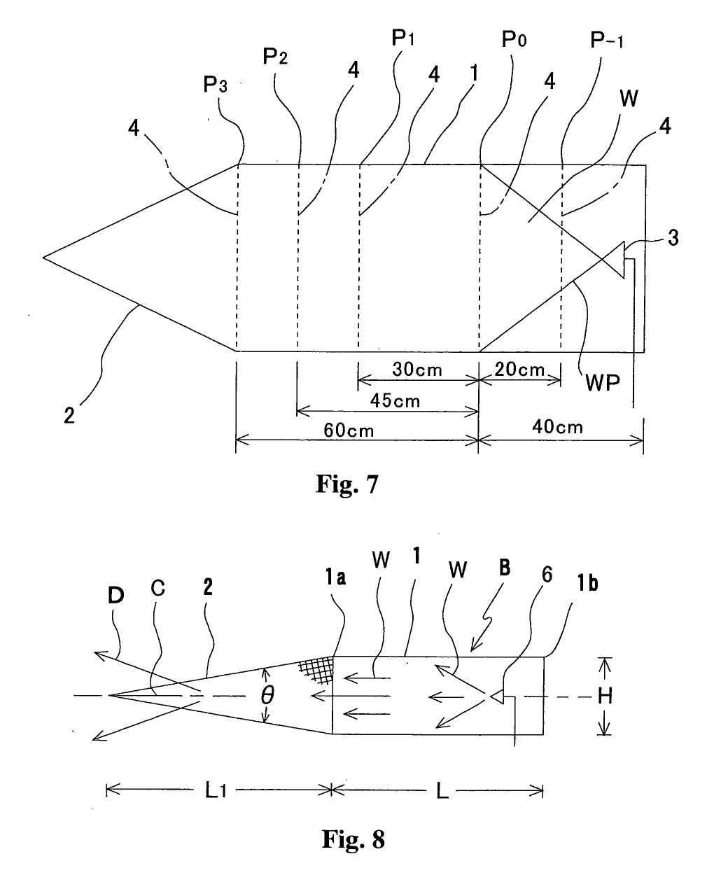

As illustrated in FIG. 7, a foam forming screen 2 was arranged at a distal end of a foam generator body 1 having an entire length of 100 cm, an emission nozzle 3 having an emission pressure of 0.5 MPa was built in at a back end side of the foam generator body 1, and P−1, P0, P1, P2, and P3 were selected as arrangement positions of an intermediate screen 4.

The position P0 is a landing position at which an outer periphery of an emission pattern WP contacts an inner wall of the foam generator body 1, and is a position of 40 cm from the back end (emission nozzle 3 side) of the foam generator body 1.

The position P−1 is on the upstream side (emission nozzle 3 side) of the landing position P0, and is a position withdrawn by 20 cm to the emission nozzle 3 side from the landing position P0.

The position P1 is a limit position at which the liquid droplets of a foam solution W radiated from the emission nozzle 3 can pass through the mesh of the intermediate screen 4, and the position P1 is spaced apart by 30 cm to the downstream side (foam forming screen 2 side) from the landing position P0. The region from the landing position P0 to the position P1 is called a liquid droplet speed regulating region.

The position P2 is positioned between the position P1 and the distal end (foam forming screen 2 side) of the foam generator body 1, and is spaced apart by 45 cm from the position P0.

The position P3 is at the position of the distal end of the foam generator body, and is spaced apart by 60 cm from the position P0.

In the intermediate screen 4, a wire diameter is between 0.5 to 0.8 mm, the number of meshes is seven or eight, spacing is between 2.5 and 3 mm, and an aperture ratio is between 60 to 70%.

The following was found as a result of the experiment.

(1) Landing position P0 to position P1 (liquid droplet speed regulating region)

When the intermediate screen 4 was perpendicularly arranged between the position P0 and the position P1, the foaming ratio was 727 to 750 times. The positions P0 to P1 are the positions at which the foaming ratio is the most suitable.

(2) Position P−1

When the intermediate screen 4 was arranged at position P−1, the foaming ratio was 686 times. The following can be assumed as the reasons the foaming ratio is not satisfactory compared to when the intermediate screen 4 was perpendicularly arranged between the landing position P0 to the position P1.

If the intermediate screen 4 is perpendicularly arranged at a position close to the emission nozzle 3, the foam solution discharged in a conical-form hits the intermediate screen 4 before hitting the inner wall of the foam generator body 1. That is, the foam solution hits the intermediate screen 4 immediately after being radiated, and thus the emission speed reduces and air cannot be sufficiently taken in.

Further, the high expansion foam fire-extinguishing system is an aspirator type in which the foam solution discharged from the emission nozzle 3 sucks surrounding air by a negative pressure generated by discharge of water. Thus, if the foam solution hits the intermediate screen 4 immediately after being discharged, the lowering in the force of the foam solution is large, and the amount of air that is taken in thereby lowers. Further, in addition thereto, the amount of air that is taken in also lowers since the contacting area between the emission pattern and the air lowers.

Regarding the foam solution impinging the intermediate screen at such position, the shape of the emission pattern reduces in a diameter direction of the cone by the resistance thereof, and the amount of foam solution that hits the outer side of the foam forming screen 2 reduces. In other words, the amount of foam solution that hits the foam forming screen 2 becomes non-uniform, the air escapes from the portion in which the amount of foam solution that hits the screen is small, and the foam cannot be generated on time at the portion in which the amount of foam solution that hits the screen is large, whereby the foaming ratio degrades.

(3) Position P2

When the intermediate screen 4 was perpendicularly arranged at position P2, the foaming ratio was 615 times. The following can be assumed as the reasons the foaming ratio is not satisfactory compared to when the intermediate screen 4 was perpendicularly arranged between the landing position P0 to the position P1.

The foam solution hits the intermediate screen 4 with the emission speed of the foam solution being reduced. When the foam solution with a speed being reduced hits the intermediate screen 4, the force is further suppressed and the foam solution cannot pass through the intermediate screen 4. Alternatively, the foam solution that does not reach the foam forming screen 2 also produces. Thus, part of the foam solution does not reach the foam forming screen 2, and foam cannot be appropriately generated.

(4) Position P3

When the intermediate screen 4 was perpendicularly arranged at position P3, the foaming ratio was 545 times. Other than the same reasons as the position P2, the following can be assumed as the reasons the foaming ratio is lower compared to when the intermediate screen 4 was perpendicularly arranged between the landing position P0 to the position P1.

The spacing between the emission nozzle 3 and the intermediate screen 4 is long, and hence the force of the foam solution that hits the intermediate screen 4 is weak. As a result, the possibility the foam generates at the stage of hitting the intermediate screen 4 becomes higher. If the speed of the foam solution is fast, the foam solution passes through the intermediate screen in the liquid state, but if the speed reduces to a certain extent, the foam solution becomes a foam when passing through the intermediate screen.

In particular, if the shape of the foam forming screen 2 is a plane and the like, and is adjacent to the intermediate screen 4, the foam generated when the foam solution W hits the intermediate screen 4 accumulates in a gap at the attachment position of the foam forming screen 2 and the intermediate screen 4. As a result, the accumulated foam becomes a hindrance in sucking air and foam cannot be satisfactorily generated from the foam forming screen 2. That is, the foam generated by the intermediate screen 4 blocks a part of the mesh of the foam forming screen 2, thereby prohibiting the entire area of the foam forming screen 2 to be used for foaming. The foaming ratio is thus unsatisfactory.

According to the above-mentioned experiment, the inventors of the present invention found that the region of the landing position P0 to the position P1, that is, the liquid droplet speed regulating region from the landing position in which the outer periphery of the emission pattern hits the inner wall of the foam generator body to the limit position in which the liquid droplet can pass through the mesh of the intermediate screen is optimum as the arrangement position of the intermediate screen, and completed the present invention based on such knowledge.

Further, in order to alleviate the degradation of the forming ratio, the inventors of the present invention have further conducted experiments and researches on the method of dropping to low speed the flow speed of the foam solution radiated from the emission nozzle at high speed before reaching the foam forming screen, and impinging the foam solution on the foam forming screen at the low speed state.

As a result, it was found that the force of the foam solution (emission energy) drops and the flow speed of impinging the foam forming screen reduces by increasing the length of the foam forming screen or the length of the foam generator body, and extending the spacing between the emission nozzle and the foam forming screen.

In other words, the foam forming screen is extended in the center axis direction, and the foam solution radiated from the emission nozzle is impinged on the foam forming screen with the speed being dropped. The distal end of the foam generator body is extended, and the foam solution radiated from the emission nozzle is impinged on the foam forming screen with the speed being dropped.

The present invention has been completed based on such knowledge.

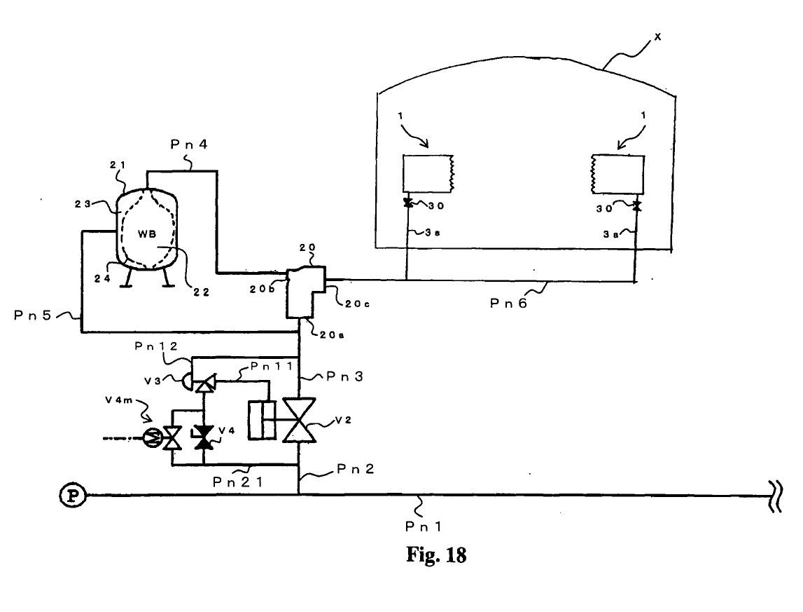

FIG. 18 is a schematic view illustrating an overall configuration of a high expansion foam fire-extinguishing system.

P denotes a pressurizing device; Pn1, a main duct for feeding water WA (extinguishing water WA) pressure-fed from the pressurizing device P; Pn2, a primary side piping; V2, a pressure-adjustment valve including a simultaneous opening valve with pressure-adjustment function, for example; Pn3, a water supply duct serving as a secondary side piping; V3, a pressure-adjustment pilot valve; V4, an activation valve; V4m, a remote activation valve, which connected in parallel to the activation valve V4, and which opens and closes by a signal from a control panel (not shown); 20, a mixer having an inlet part 20a connected to the water supply duct Pn3, that is, connected to the secondary side of the pressure-adjustment valve V2, and including a foam liquid injection port 20b; and 21, a foam liquid tank in which a liquid chamber 22 connected to the foam liquid injection port 20b of the mixer 20 through an intermediation of a foam liquid piping Pn4 and stored with a foam extinguishing agent WB (foam liquid WB) and a water chamber 23 connected to the primary side of the foam mixer 20 through an intermediation of a water feeding piping Pn5 are separated by a separating membrane 24.

Pn6 denotes a water solution piping, connected to the secondary side of the foam mixer 20, for feeding the foam solution W; 3a, a branched duct branched from a piping Pn6; 1, a foam generator including a flow path tube 2 supplied with foam solution W from the foam mixer 20 through an intermediation of the piping Pn6 and the branched duct 3a and ejecting the same from the emission nozzle 3 to generate foam; 30, a selection valve serving as an open/close mechanism, which is arranged on the branched duct 3a, and open/close controlled by a remote operation from the control panel (not shown); and X, a room X or a discharge section provided with the foam generator 1.

The operation is described in further detail with reference to FIG. 18.

When fire breaks out in the room X, a fire detector (not shown) detects the fire and sends a fire signal to the control panel. When an activation signal of the foam fire-extinguishing system is output from the control panel by the judgment of the fire prevention personnel or automatically, the activation signal reaches and activates the remote activation valve V4m, the pressurizing device P, and the selection valve 30.

When the remote activation valve V4m opens, the primary pressure stepped up by the pressurizing device P passes from the primary side piping Pn2 to the accumulator (not shown) of the pressure-adjustment valve V2 through an intermediation of the piping Pn21, the remote activation valve V4m, the pressure-adjustment pilot valve V3, and the piping Pn11, and opens the pressure-adjustment valve in the alarm-time closed state (function of simultaneous opening valve). When the water supply duct Pn3 is filled with water, the up and down fluctuation of pressure of the water supply duct Pn3, that is, the pressure extraction destination of the pressure by the pressure extraction piping Pn12 is not described in detail but is adjusted to approach the set pressure set by the pressure-adjustment pilot valve V3.

When the extinguishing water WA passed through the pressure-adjustment valve V2 passes through the mixer 20, the extinguishing water WA also flows into the water feeding piping Pn5 and enters the water chamber 23. The amount of fed extinguishing water is such that the foam liquid WB of the liquid chamber 22 is discharged through an intermediation of the separating membrane 24 as if being pushed out and injected to the foam liquid injection port 20b through an intermediation of the foam liquid piping Pn4. Thus, the foam mixer 20 mixes the extinguishing water WA and the foam liquid WB at a constant ratio.

In this case, the foam liquid WB is injected to the mixer 20 in a separating membrane form using the extinguishing water WA on the primary side equal to the water feeding pressure to the mixer 20 while being pushed out so as not to mix, and thus the energy loss is small or the pressure loss is small with respect to the suction of the foam liquid WB. If the foam mixer 20 attached with the foam liquid tank 21 with the separating membrane 24 as illustrated in FIG. 18 is arranged, the solution passes through the foam mixer 20 having a relatively small pressure loss. Thus, a nozzle pressure having a relatively small error with respect to the design value is obtained, and a stable foaming performance and extinguishing performance can be obtained.

After the foam mixer 20, the selection valve 30 corresponding to the foam generator 1 that requires foaming is opened, and the foam solution W is ejected towards the foam forming screen 2 from the emission nozzle 3 in the foam generator 1.

### First Embodiment

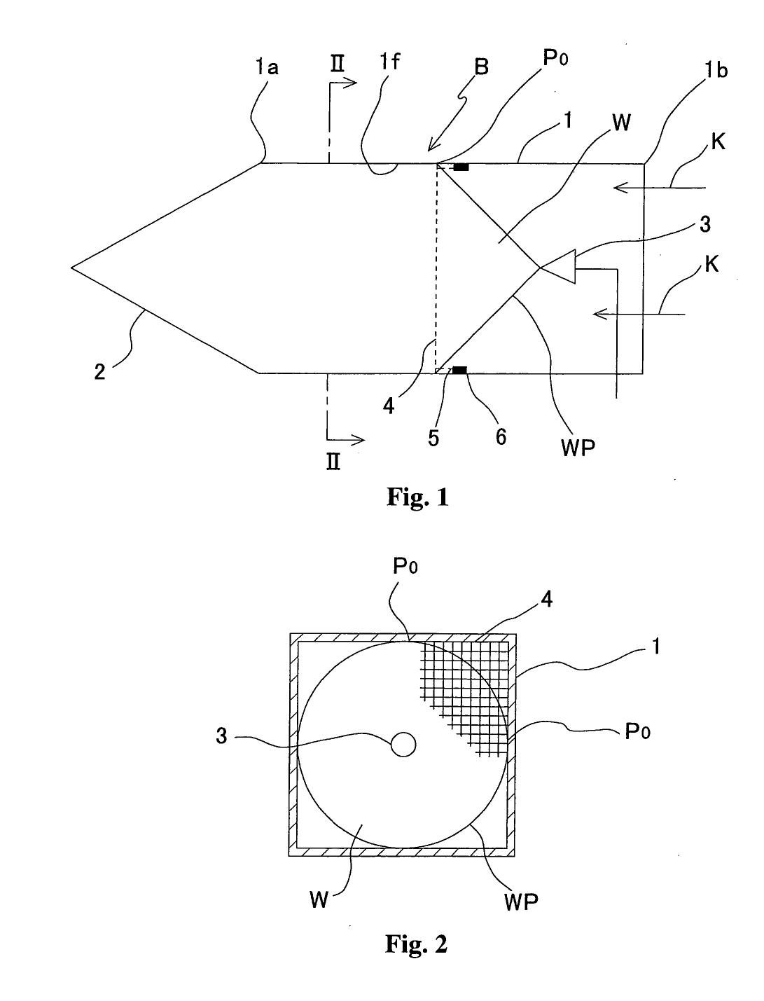

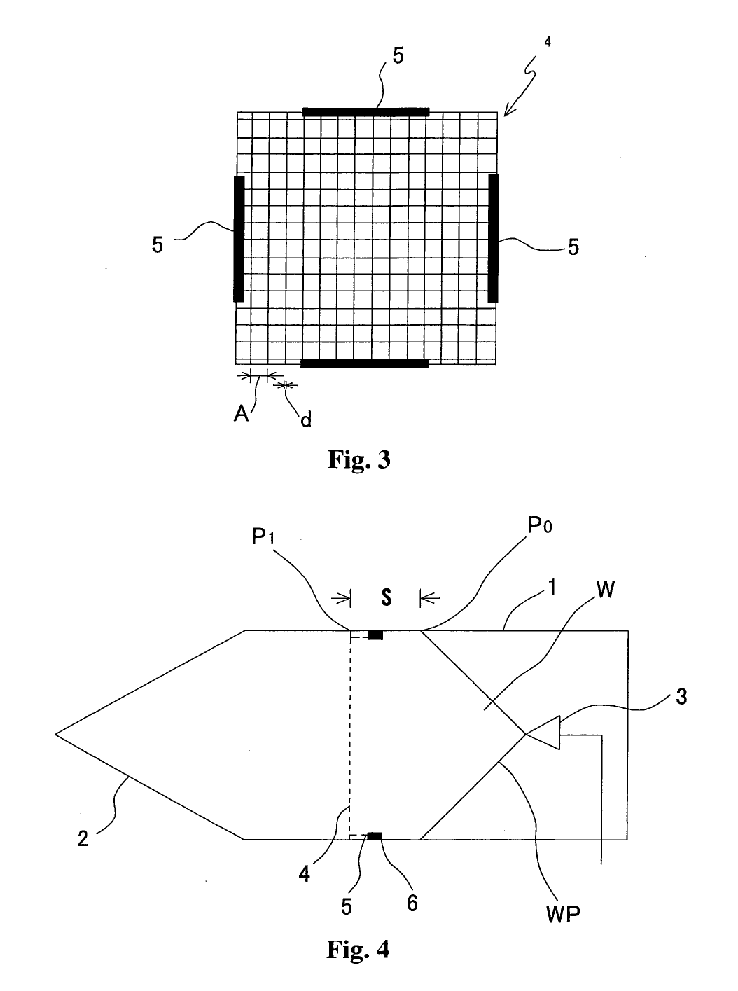

The first embodiment of the present invention is described with reference to FIGS. 1 to 3.

A foam generator B of a high expansion extinguishing facility is arranged in a room (chamber) of a fire monitoring section. The foam generator B is set to a foaming ratio of 500, for example.

The foam generator B includes a foam generator body 1 having a tubular shape such as having a cross-section of a square, and has the horizontal length L of 900 mm and the vertical length (height) H of 640 mm. The foam forming screen 2 is arranged at the distal end 1a side of the foam generator body 1. The emission nozzle 3 is built in on the back end 1b side of the foam generator body 1 at the position spaced apart by a predetermined distance such as 90 cm from the foam forming screen 2. The emission nozzle 3 radiates the foam solution W with an emission pattern WP spreading conically towards the foam forming screen 2.

The interior of the foam generator body 1 is partitioned by the intermediate screen 4. The intermediate screen 4 is perpendicularly arranged in the body 1, and the attachment 5 thereof is fixed to an inner wall 1f by a bis 6. The intermediate screen 4 is arranged at the position P0 (landing position) in which the outer periphery of the emission pattern WP hits the inner wall if of the foam generator body 1, but the position P0 is spaced apart by 40 cm from the back end 1b of the foam generator body 1 on the emission nozzle 3 side from the center in the longitudinal direction of the foam generator body 1.

The intermediate screen 4 is formed to a square, and has the wire diameter of 0.65 mm, the number of meshes of seven, the spacing of 2.98 mm, and the aperture ratio of 67.39%. Such dimensions are appropriately selected, as necessary, but the suitable selection range is such that the wire diameter is between 0.5 to 0.8 mm, the number of meshes is seven or eight, the spacing is between 2.5 to 3 mm, and the aperture ratio is between 60 to 70%.

The aperture ratio ε can be obtained from the following equation. Here, A is the spacing and d is the wire diameter.

ε={A/(A+d)}²×100

Next, the operation of this embodiment is described.

When fire breaks out in the fire monitoring section, the fire detector (not shown) detects the fire and sends the fire signal to the control panel.

The control panel then activates the high expansion foam fire-extinguishing system, whereby the air in the room, that is, the air K in the nearby room where the foam generator body 1 is arranged is sucked in the foam generator body 1, and the foam solution W is radiated from the emission nozzle 3 in the form of liquid droplets while drawing a conical emission pattern WP).

In this case, the emission angle of the emission nozzle 3 is an obtuse angle so that the foam solution can hit the entire intermediate screen in a short distance, whereby the entire length of the foam generator body 1 can be reduced compared to when the emission angle is an acute angle.

The outer periphery of the emission pattern WP hits the inner wall of the foam generator body 1, and at the same time, the foam solution W in the form of liquid droplets passes through the mesh while being subjected to the resistance of the intermediate screen 4 to be decelerated. Thus, after being decelerated by the intermediate screen 4, the foam solution W impinges the foam forming screen 2 and passes through the mesh thereby generating foam.

The flow-in speed to the mesh of the foam forming screen 2 is regulated by the intermediate screen 4 and slowed down though the emission pressure from the emission nozzle 3 is high, and thus the foam solution W is at a speed of easily foaming. The liquid droplets of the foam solution W thus can efficiently form high expansion foam.

### Second Embodiment

The second embodiment of the present invention is described with reference to FIG. 4, and the same reference symbols as illustrated in FIGS. 1 to 3 are given the same name and function. This embodiment differs from the first embodiment in the configuration of the foam generator (foam generator of this embodiment), and the other system configuration is substantially the same.

The difference between this embodiment and the first embodiment lies in the arrangement position of the intermediate screen 4. That is, the arrangement position P1 is the limit position in which the liquid droplets of the foam solution W radiated from the emission nozzle 3 can maintain the flow speed of passing through the mesh of the intermediate screen 4.

As described above, in this embodiment, the region from the landing position P0 in which the outer periphery of the emission pattern hits the inner wall of the foam generator body to the limit position P1 in which the liquid droplets can pass through the mesh of the intermediate screen 4 is called the liquid droplet speed regulating region. The position P1 is spaced apart by a predetermined distance S from the landing position P0, and the predetermined distance S is, for example, 30 cm. The length of the liquid droplet speed regulating region is formed to be the length same or substantially equal to the length of multiplying 0.3 to the entire length of the foam generator body 1.

In this embodiment as well, the foam solution W impinges the foam forming screen 2 after having the flow speed appropriately regulated by the intermediate screen 4, whereby the designed foaming ratio can be obtained.

### Third Embodiment

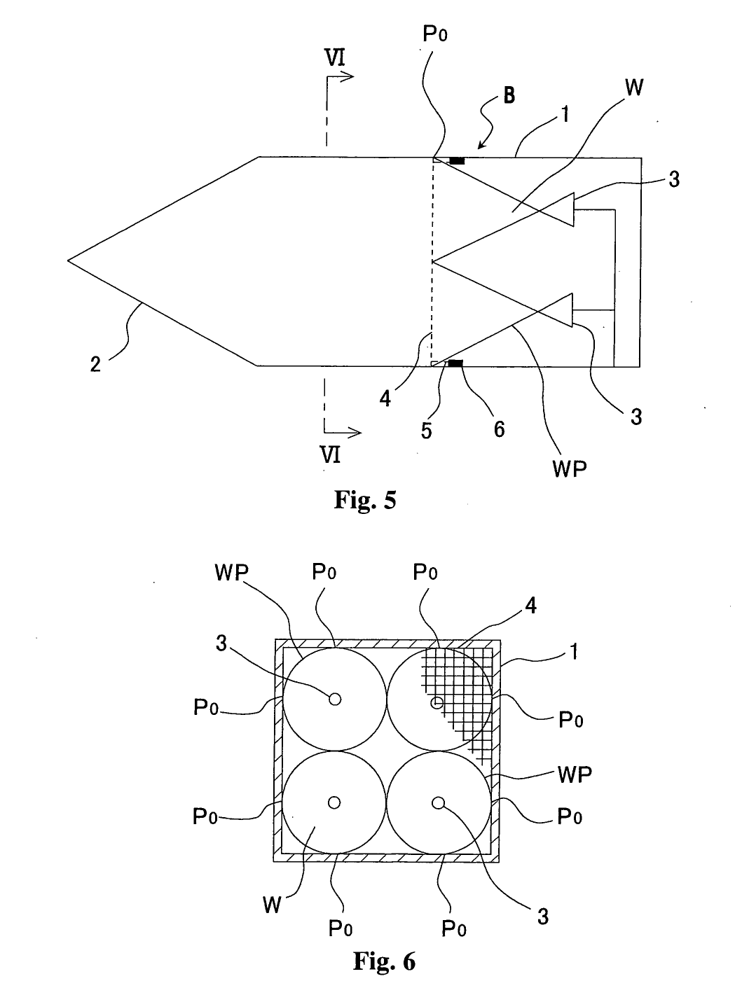

The third embodiment of the present invention is described with reference to FIGS. 5 and 6, and the same reference symbols as illustrated in FIGS. 1 to 3 are given the same name and function. This embodiment differs from the first embodiment in the configuration of the foam generator (foam generator of this embodiment), and the other system configuration is substantially the same.

The difference between this embodiment and the first embodiment lies in that a plurality of emission nozzles 3 are arranged. The number of emission nozzles 3 is, for example, four, and such nozzles 4 are arranged in parallel, each distal end thereof being positioned on the same perpendicular surface.

The embodiments of the present invention are not limited to the above, and the intermediate screen 4 may be arranged tilted by a predetermined angle instead of being perpendicularly arranged. The tilt angle can be appropriately selected within the range of between 1 and 30 degrees.

In addition, the spacing of the intermediate screen does not need to be even, and the size of the spacing can be appropriately selected according to the pressure distribution of the foam solution radiated from the emission nozzle 3.

### Fourth Embodiment

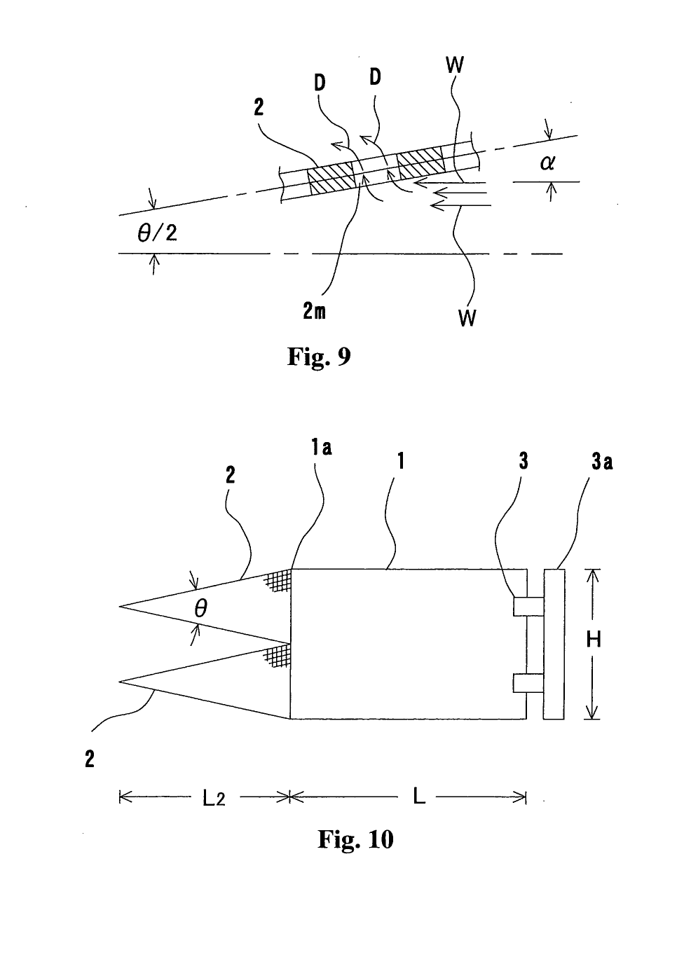

The fourth embodiment of the present invention is described with reference to FIGS. 8 and 9, and the same reference symbols as illustrated in FIGS. 1 to 7 are given the same name and function. This embodiment differs from the first embodiment in the configuration of the foam generator (foam generator of this embodiment), and the other system configuration is substantially the same.

The foam forming screen 2 is formed to a triangular prism shape (triangular cross-section) folded so as to project to the distal end side, and the distal end angle θ is 20 degrees, but the distal end angle θ may be appropriately selected within a range of between 15° and 40°. The length L1 in the direction of the center axis C of the foam forming screen 2 is 908 mm.

The length L1 is appropriately selected within a range (L×⅔≦L1 ≦L) from a length of substantially the same length as the entire length L of the foam generator body 3 to the length of two thirds of the entire length L.

Next, the operation of this embodiment is described below.

When fire breaks out in the room, the smoke detector (not shown) detects the fire, and sends a fire signal to the control panel. The control panel then activates the high expansion foam fire-extinguishing system, and hence the air in the room, that is, the air of the nearby room arranged with the foam generator B is sucked in the foam generator body 1, the foam solution W being discharged from the emission nozzle 3 in the form of liquid droplets.

The foam solution W flows down towards the foam forming screen 2 at high speed. However, the distance between the emission nozzle 3 and the foam forming screen 2 is longer than the related art, and hence the force (emission energy) drops while flowing down, whereby the foam solution impinges the foam forming screen 2 with reduced flow speed, involves air, and generates foam.

Thus, the foam is easily generated, and the degradation of the foaming ratio under smoke situation can be alleviated. In order to take away the force (emission energy) of the radiated foam solution W, the intermediate screen 4 may be arranged in the foam generator body 1.

Further, the foam forming screen 2 is formed to a triangular prism shape (triangular cross-section), and hence the area becomes larger than that of the foam forming screen stretched in a direction orthogonal to the center axis C. The contacting area with the foam solution thus increases, and the foaming ratio further is enhanced.

The distal end angle of the foam forming screen 2 is an acute angle of smaller than or equal to 45° of between 15° and 40°, and is formed to a triangular cross-section, and thus, as illustrated in FIG. 9, the contacting angle α between the foam solution W and the foam forming screen 2 becomes small. As a result, the mesh 2m is laid down, and the opening becomes small with respect to the direction the foam solution W flows. Thus, the foam solution becomes difficult to pass through the mesh 2m compared to the foam forming screen stretched in the orthogonal direction and having the contact angle of 90 degrees.

Consequently, the force of the foam solution W drops while flowing down through the foam generator body 1 so that the flow speed becomes slow, and the foam solution W impinges the foam forming screen 2 as if sliding on the surface of the foam forming screen 2 in the slowed down state, passes through the mesh 2m, involves air to generate foam D, and then discharges to the outside. Thus, the degradation of the foaming ratio under smoke situation is further alleviated.

### Fifth Embodiment

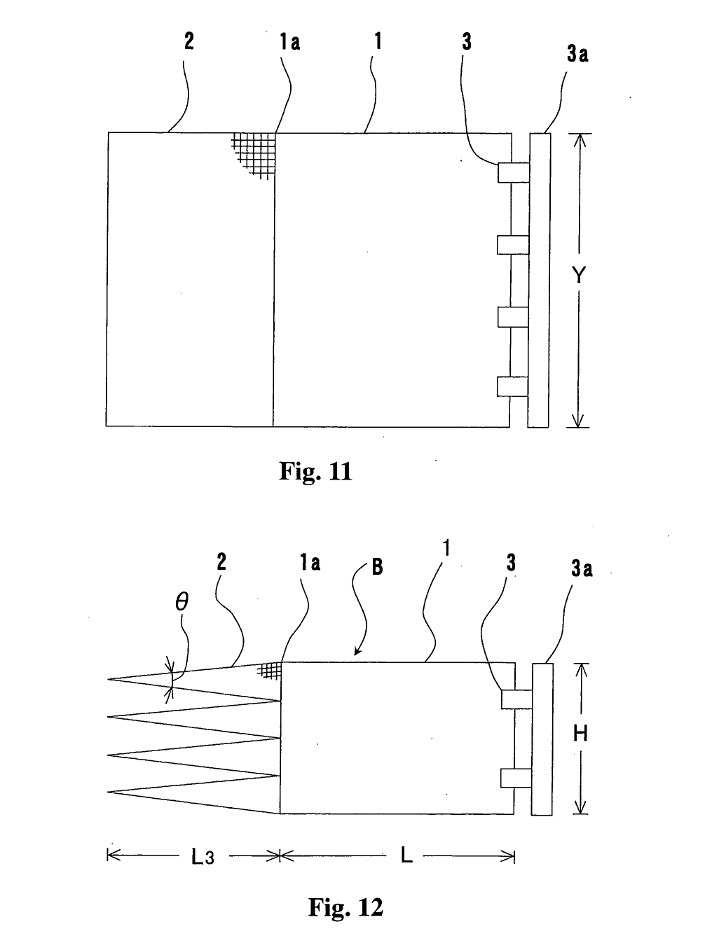

The fifth embodiment of the present invention is described with reference to FIGS. 10 and 11, and the same reference symbols as illustrated in FIGS. 1 to 9 are given the same name and function. differs from the first embodiment in the configuration of the foam generator (foam generator of this embodiment), and the other system configuration is substantially the same.

The difference between this embodiment and the fourth embodiment is that two (plural) foam forming screens 2 are arranged in a height direction of the foam generator body 1. Further, the piping 3a connected with the nozzle 3 is arranged on the outer side of the foam generator body 1.

The two upper and lower foam forming screens 2 have the same structure, and are formed to have a distal end angle θ of 30°, the length L2 of the foam forming screen 2 of 597 mm, and the width Y of 1280 mm. The length L and the height H of the foam generator body 1 are the same as the fourth embodiment. That is, the length L2 of the foam forming screen 2 is a length of substantially two thirds of the entire length L of the foam generator body 1.

In this embodiment, the foam forming screens 2 are configured to two upper and lower stages, and each distal end angle θ is formed large. Thus, the projection amount L2 of the foam forming screen 2 from the distal end 1a of the foam generator body 1 is reduced to about two thirds compared to the length L1 of the fourth embodiment, but the area of the foam forming screen 2 of triangular prism shape becomes sufficiently large.

Further, the foam generator body in which one foam forming screen 2 of triangular prism shape having a distal end angel of 30° is provided and the foam generator body in which the height on the distal end 1a side of the foam generator body 1 is halved and the foam forming screens 2 are arranged in two upper and lower stages have substantially the same area, but the projection amount from the foam generator body 1 can be substantially halved, and the entire foam generator body can be miniaturized in the latter foam generator body.

### Sixth Embodiment

The sixth embodiment of the present invention is described with reference to FIG. 12, and the same reference symbols as illustrated in FIGS. 1 to 11 are given the same name and function. This embodiment differs from the first embodiment in the configuration of the foam generator (foam generator of this embodiment), and the other system configuration is substantially the same.

The difference between this embodiment and the fifth embodiment (FIGS. 10 and 11) is that four (plural) foam forming screens 2 are arranged in the height direction of the foam generator body 1, that is, two foam forming screens 2 are arranged for one nozzle 3. The four foam forming screens 2 have the same structure, and each are formed to have a distal end angle θ of 15° and the length L3 of the foam forming screen 2 of 615 mm. Further, the length L3 of the foam forming screen 2 is a length of substantially two thirds of the entire length L of the foam generator body 1.

### Seventh Embodiment

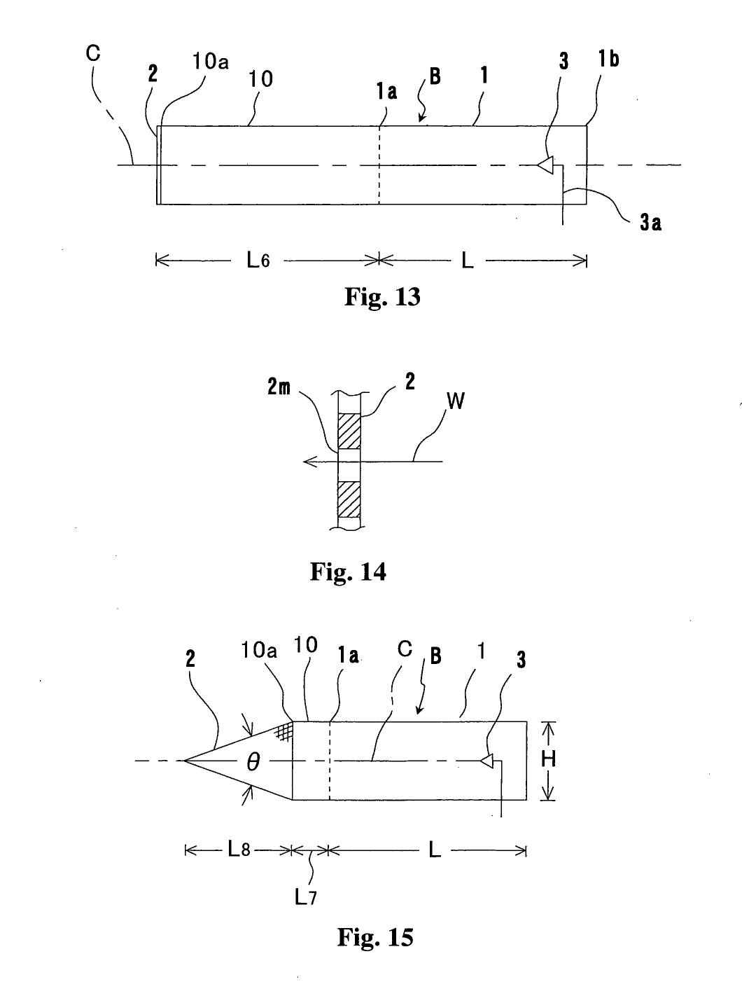

The seventh embodiment of the present invention is described with reference to FIGS. 13 and 14, and the same reference symbols as illustrated in FIGS. 1 to 12 are given the same name and function. This embodiment differs from the first embodiment in the configuration of the foam generator (foam generator of this embodiment), and the other system configuration is substantially the same.

The difference between this embodiment and the fourth embodiment is as follows.

(1) The distal end 1a of the foam generator body 1 is extended by a length L6, and the foam forming screen 2 is stretched at the distal end 10a of the extended portion 10. The length L6 of the extended portion 10 is formed to the same length as the entire length L of the foam generator body 1. The length L6 is appropriately selected within a range (L×⅔≦L1≦L) from the length substantially the same as the entire length L to the length of substantially two thirds of the entire length L. The length of the extended portion 10 is adjusted such that the emission energy of the foam solution W radiated from the nozzle 3 is lowered and the foam solution W hits the foam forming screen 2 at the flow speed of the foam solution W in which sufficient foaming ratio can be obtained even under smoke situation. The length of the foam generator body 1 without the extended portion 10 is the length at which the radiated foam obtains an optimum foaming ratio under normal air.

(2) The foam forming screen 2 is formed to a flat plate, and is stretched in a direction orthogonal to the center axis C.

As illustrated in FIG. 14, in this embodiment, the mesh 2m is wider compared to when the foam forming screen 2 is stretched so as to have a triangular prism shape, and the foam solution easily passes through. However, the foam solution impinges the foam forming screen 2 with the speed of the liquid droplet of the foam solution being dropped because the foam forming screen 2 is sufficiently spaced apart from the emission nozzle 3. Thus, the degradation of the foaming ratio can be alleviated.

### Eighth Embodiment

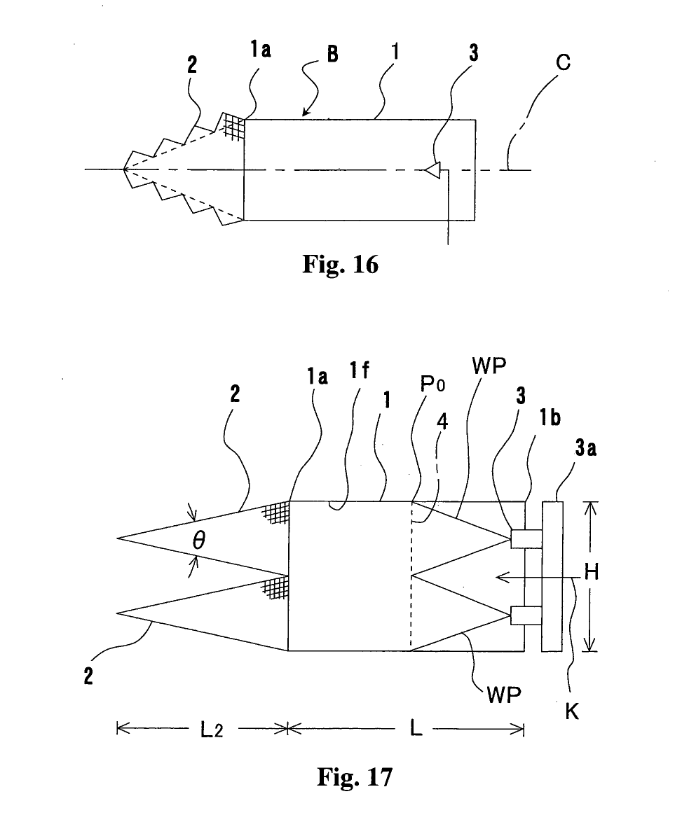

The eighth embodiment of the present invention is described with reference to FIG. 15, and the same reference symbols as illustrated in FIGS. 1 to 14 are given the same name and function. This embodiment differs from the first embodiment in the configuration of the foam generator (foam generator of this embodiment), and the other system configuration is substantially the same.

The difference between this embodiment and the fourth embodiment is that the distal end of the foam generator body 1 is extended by the length L7 to form the extended portion 10. The length L7 of the extended portion 10 is 167 mm, and the length L8 of the foam forming screen 2 is 523 mm. The flow speed at which the foam solution W hits the foam forming screen 2 is dropped, and the degradation of the foaming ratio under the smoke situation can be alleviated by arranging the extended portion 10.

### Ninth Embodiment

The ninth embodiment of the present invention is described with reference to FIG. 16, and the same reference symbols as illustrated in FIGS. 1 to 15 are given the same name and function. This embodiment differs from the first embodiment in the configuration of the foam generator (foam generator of this embodiment), and the other system configuration is substantially the same.

The difference between this embodiment and the fourth embodiment is that the foam forming screen 2 has a surface provided with the irregularity, and that the area of the foam forming screen is further increased and the contacting area is increased compared to the foam forming screen having a triangular prism shape indicated by the dashed line.

### Tenth Embodiment

The tenth embodiment of the present invention is described with reference to FIG. 17, and the same reference symbols as illustrated in FIGS. 1 to 16 are given the same name and function. This embodiment differs from the first embodiment in the configuration of the foam generator (foam generator of this embodiment), and the other system configuration is substantially the same.

The difference between this embodiment and the fifth embodiment is that the foam forming screen 2 is spaced apart from the emission nozzle 3, and the intermediate screen 4 is arranged between the foam forming screen 2 and the emission nozzle.

What is claimed is:

1. A high expansion foam fire-extinguishing system, comprising:
a foam generator body formed to a tubular shape;
a foam forming screen arranged at a distal end side of the foam generator body;
an emission nozzle arranged at a back end side of an interior of the foam generator body, for radiating a foam solution in an emission pattern that spreads in a conical shape towards the foam forming screen; and
an intermediate screen arranged between the foam forming screen and the emission nozzle,
wherein the intermediate screen is arranged in a liquid droplet speed regulating region from a landing position at which an outer periphery of the emission pattern hits an inner wall of the foam generator body to a limit position at which liquid droplets can pass through a mesh of the intermediate screen.

2. A high expansion foam fire-extinguishing system according to claim 1, wherein a distance of the liquid droplet speed regulating region is a distance obtained by multiplying an entire length of the foam generator body by 0.3.

3. A high expansion foam fire-extinguishing system according to claim 1, wherein the intermediate screen is arranged on an emission nozzle side from a center in a length direction of the foam generator body.

4. A high expansion foam fire-extinguishing system according to claim 2, wherein the intermediate screen is arranged on an emission nozzle side from a center in a longitudinal direction of the foam generator body.

5. A high expansion foam fire-extinguishing system according to claim 1, wherein the emission pattern is an obtuse angle.

6. A high expansion foam fire-extinguishing system according to claim 2, wherein the emission pattern is an obtuse angle.

7. A high expansion foam fire-extinguishing system according to claim 3, wherein the emission pattern is an obtuse angle.

8. A high expansion foam fire-extinguishing system according to claim 4, wherein the emission pattern is an obtuse angle.

9. A high expansion foam fire-extinguishing system, comprising:
a foam generator body formed to a tubular shape;
a foam forming screen arranged at a distal end side of the foam generator body; and
an emission nozzle arranged at a back end side of an interior of the foam generator body, for radiating a foam solution towards the foam forming screen,
wherein a length of the foam forming screen is in a range from a length substantially the same as an entire length of the foam generator body to a length of substantially two thirds of the entire length.

10. A high expansion foam fire-extinguishing system according to claim 9, wherein the foam forming screen is bent to project to the distal end side so that a distal end angle thereof is set between 15° to 40°.

11. A high expansion foam fire-extinguishing system according to claim 10, wherein at least two of the foam forming screens are arranged in a height direction of the foam generator body.

12. A high expansion foam fire-extinguishing system, comprising:
a foam generator body formed to a tubular shape;
a foam forming screen arranged at a distal end side of the foam generator body; and
an emission nozzle arranged at a back end side of an interior of the foam generator body, for radiating a foam solution towards the foam forming screen,
wherein a distal end of the foam generator body is extended within a range from a length substantially the same as an entire length of the foam generator body to a length of substantially two thirds of the entire length.

13. A high expansion foam fire-extinguishing system according to claim 12, wherein the foam forming screen is stretched in a direction orthogonal to a center axis of the foam generator body.
